(19) United States
(12) Patent Application Publication
(10) Pub. No.: US 2009/0108753 A1
(43) Pub. Date: Apr. 30, 2009

(54) PLASMA DISPLAY DEVICE AND METHOD OF MANUFACTURING THE SAME

(75) Inventors: Ryo MATSUBARA, Osaka (JP); Hirotsugu FUSAYASU, Kyoto (JP); Hiroshi KUNIMOTO, Osaka (JP); Kei ICHIKAWA, Osaka (JP); Seiji HAMADA, Osaka (JP)

Correspondence Address: HAMRE, SCHUMANN, MUELLER & LARSON P.C., P.O. BOX 2902-0902, MINNEAPOLIS, MN, 55402, US

(73) Assignee: Panasonic Corporation, Kadoma-shi, Osaka (JP)

(21) Appl. No.: 12/251,825

(22) Filed: Oct. 15, 2008

(30) Foreign Application Priority Data
Oct. 31, 2007 (JP) 2007-284131

(51) Int. Cl. H01J 17/49; H01J 9/24

(52) U.S. Cl. 313/582; 445/24

(57) ABSTRACT

The present invention provides a plasma display device that allows, at a low cost, reliable electrical connection between a film and a conductive member with low impedance as well as prevention of friction between them. This plasma display device includes a transparent substrate, a film attached to the rear surface of the transparent substrate, a back cover, and a conductive member for connecting the film and the back cover electrically. Convex portions are formed at a predetermined distance apart from each other on the facing surface of the conductive member facing the periphery of the film, while a concave portion or concave portions are formed on the rear surface of the transparent substrate. The convex portions are thus fitted in the concave portion or the concave portions with the film interposed therebetween.

### BACKGROUND OF THE INVENTION

1. Field of the Invention

The present invention relates to a plasma display device, which is a flat panel display device using a plasma display panel (hereinafter referred to as a “PDP”) as a display device, and a method of manufacturing the plasma display device.

2. Related Background Art

Conventionally, plasma display devices are designed to shield the periphery of a PDP for blocking unnecessary radiation of electromagnetic waves emitted from the PDP from leaking to the outside of the device. For example, JP 2001-141972 A discloses a plasma display device configured as shown in FIG. 8. This plasma display device includes: a frame 11; an optical filter 13 disposed inside the frame 11; a frame-shaped conductive member 17 that holds the optical filter 13 by pressing the periphery of the optical filter 13 against the frame 11 so as to interpose the optical filter 13 between the frame 11 and itself; and a conductive back cover 16 fixed to the frame 11 together with the conductive member 17. A PDP 12 is enclosed in the space surrounded by the optical filter 13, the conductive member 17 and the back cover 16.

The optical filter 13 transmits image light emitted from the PDP 12, but blocks electromagnetic waves therefrom. The optical filter 13 has a transparent substrate 14 made of resin, glass, or the like, and a film 15 including a conductive layer (such as a metal mesh layer). The film 15 is attached to the surface of the transparent substrate 14 located at the side of the PDP 12. When this film 15 is connected electrically to the conductive member 17, a shield case enclosing the PDP 12 is obtained. In the plasma display device disclosed in JP 2001-141972 A, a conductive gasket 18 is placed between the film 15 and the conductive member 17 in order to connect the film 15 and the conductive member 17 electrically with low impedance and with reliability.

However, the conductive gasket 18 is expensive. The use of this gasket 18 increases the manufacturing cost of the plasma display device, which is a problem. On the contrary, when the gasket 18 is not used, it becomes difficult to bring the conductive member 17 and the film 15 into surface contact with each other entirely, which increases the impedance. In addition, vibrations generated during transportation cause the film 15 and the conductive member 17 to rub against each other on their contact surfaces. The friction between them damages the contact surfaces, which may cause poor contact therebetween.

### SUMMARY OF THE INVENTION

The present invention has achieved a solution to the above problems, and it is an object of the present invention to provide a plasma display device that allows, at a low cost, reliable electrical connection between a film and a conductive member with low impedance as well as prevention of friction between them, and to provide a method of manufacturing this plasma display device.

In order to achieve the above object, the present invention provides a plasma display device including: a PDP; a transparent substrate disposed at a front side of the PDP; a film attached to a first surface of the transparent substrate and having a conductive layer; a conductive back cover disposed at a rear side of the PDP; and a conductive member that electrically connects a periphery of the film and a periphery of the back cover. In this plasma display device, the conductive member has a facing surface facing the periphery of the film at a side opposite to the transparent substrate, and convex portions are formed on the facing surface at a predetermined distance apart from each other, and a concave portion or concave portions are formed on the first surface of the transparent substrate, and the convex portions are fitted in the concave portion or the concave portions with the film interposed therebetween.

The present invention also provides a method of manufacturing a plasma display device, including pressing a conductive member against a transparent substrate from a side of a film of the substrate, the conductive member having a facing surface facing a periphery of the film and convex portions formed on the facing surface at a predetermined distance apart from each other, and the transparent substrate having a first surface with a concave portion or concave portions formed on the periphery thereof and with the film having a conductive layer attached to the first surface, so that the convex portions are pressed into the concave portion or the concave portions so as to penetrate the film, and thus the convex portions are fitted in the concave portion or the concave portions with the film interposed therebetween.

In the plasma display device obtained by the present invention, the convex portions are formed at a predetermined distance apart from each other on the facing surface of the conductive member facing the periphery of the film. In other words, the convex portions are provided in places along the profile of the film, and these convex portions are fitted in the concave portion(s) of the transparent substrate. Therefore, it is possible to prevent a relative displacement between the conductive member and the film attached to the transparent substrate, and thus prevent friction between the film and the conductive member. In addition, the convex portions are fitted in the concave portion(s) with the film interposed therebetween. Therefore, it is possible not only to bring the conductive member into surface contact with the film reliably but also to secure a large contact area, and thus to maintain the impedance therebetween at a low level. As described above, according to the present invention, it is possible to achieve, without using a conductive gasket but at a low cost, prevention of friction between the film and the conductive member as well as reliable electrical connection between them with low impedance.

### BRIEF DESCRIPTION OF THE DRAWINGS

FIG. 1 is a cross-sectional view of a plasma display device according to one embodiment of the present invention;

FIG. 2 is an enlarged view of a main portion of FIG. 1;

FIG. 3 is a rear view of an optical filter;

FIG. 4 is a cross-sectional view taken along a line IV-IV of FIG. 3;

FIG. 5 is a front view of a conductive member;

FIG. 6 is an enlarged perspective view of the conductive member of FIG. 5;

FIG. 7 is a cross-sectional view of an optical filter of a modification; and

FIG. 8 is a cross-sectional view of a conventional plasma display device.

### DETAILED DESCRIPTION OF THE INVENTION

Hereinafter, one embodiment of the present invention will be described in detail with reference to the accompanying drawings. The embodiment described below is merely exemplary of the present invention, and should not be construed to limit the scope of the present invention.

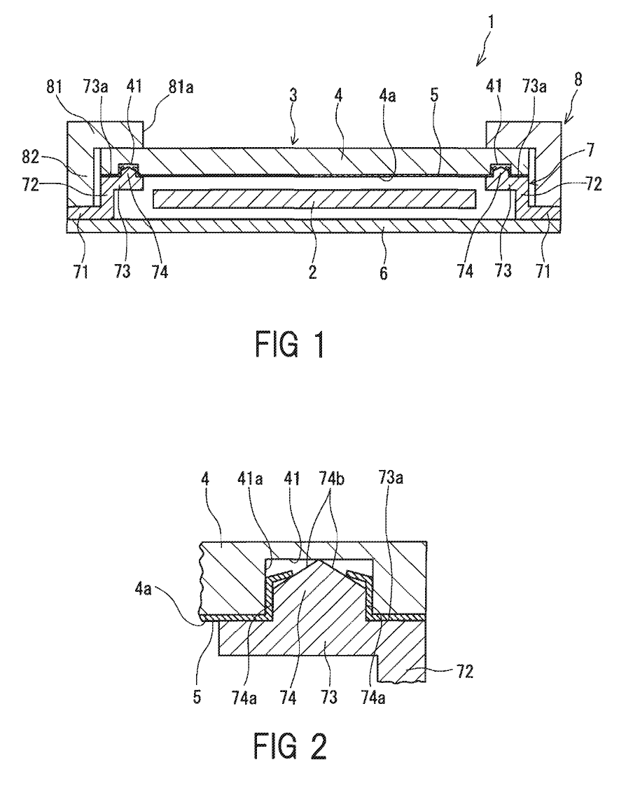

As shown in FIG. 1, a plasma display device according to one embodiment of the present invention includes: a PDP 2; an optical filter 3 disposed at the front side of the PDP 2; a frame 8 that covers the periphery of the front surface of the optical filter 3; a conductive member 7 that holds the periphery of the optical filter 3 so as to be interposed between the frame 8 and itself; and a back cover 6 disposed at the rear side of the PDP 2.

The frame 8 is made of resin, for example. The frame 8 has a rectangular frame shape as viewed from the front, and has four sides, each having an approximately L-shaped cross-section. Specifically, the frame 8 has a front plate 81 forming a window 81a, and a peripheral wall 82 extending from the peripheral edge of the front plate 81 toward the rear side thereof.

The optical filter 3 has a transparent substrate 4 made of glass or resin such as acrylic resin, and a film 5 which is attached to the rear surface (which corresponds to the first surface of the present invention) 4a of the transparent substrate 4 located at the side of the PDP 2 so as to cover almost the entire rear surface thereof. The film 5 includes a base layer made of a polyester film or the like, and a conductive layer formed on the base layer. The conductive layer has a metal mesh and a metal frame surrounding the metal mesh. The film 5 is held by the transparent substrate 4 in such a manner that the conductive layer is exposed toward the PDP 2.

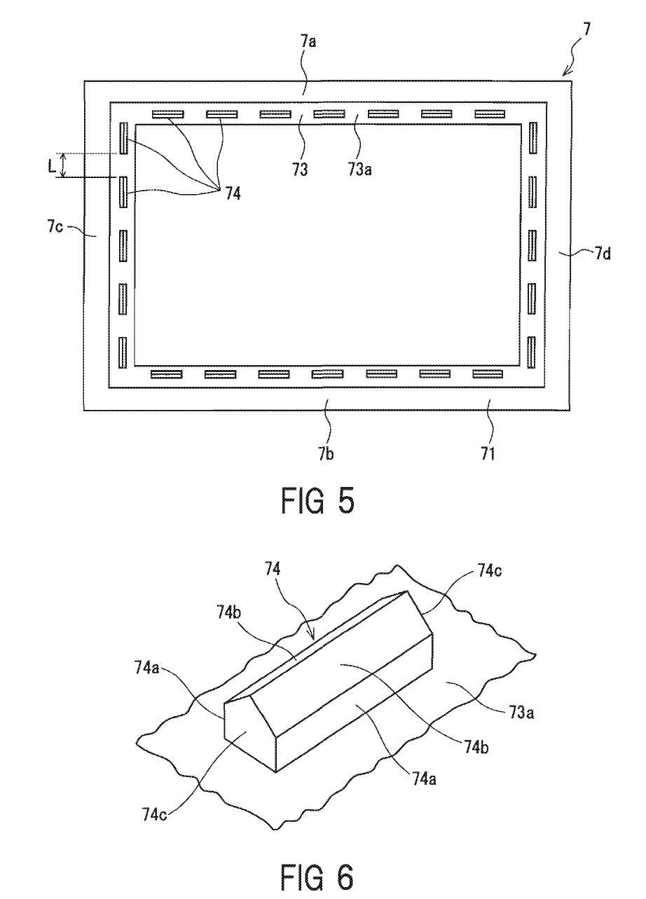

The conductive member 7 also is called a pressing metal member, and includes four side portions 7a to 7d, as shown in FIG. 5. The conductive member 7 has a rectangular frame-shaped fixing portion 71 to be fixed to the end surface of the peripheral wall 82 of the frame 8, a rectangular frame-shaped pressing portion 73 for pressing the periphery of the optical filter 3, and a rectangular cylindrical connecting portion 72 (see FIG. 1) for connecting the inner periphery of the fixing portion 71 and the outer periphery of the pressing portion 73. The rectangular frame shape of the pressing portion 73 is slightly smaller than that of the fixing portion 71. Specifically, the surface of the pressing portion 73 located at the side of the optical filter 3 is a facing surface 73a facing the periphery of the film 5 at the side opposite to the transparent substrate 4. When the fixing portion 71 is fixed to the end surface of the peripheral wall 82, the periphery of the optical filter 3 is pressed against the front plate 81 of the frame 8 by the pressing portion 73, and the pressing portion 73 and the conductive layer of the film 5 are connected electrically. The four side portions 7a to 7d are individually pressed into shape.

The back cover 6 is a conductive cover obtained by pressing a metal plate into shape (which is simplistically shown as a plate in FIG. 1). When the periphery of the back cover 6 is fixed with screws to the end surface of the peripheral wall 82 of the frame 8 together with the fixing portion 71 of the conductive member 7, the back cover 6 is connected electrically with the conductive member 7. In other words, the periphery of the back cover 6 and the periphery of the film 5 are connected electrically to each other through the conductive member 7.

Furthermore, in the present embodiment, a plurality of convex portions 74 are formed on the facing surface 73a of the conductive member 7, as shown in FIG. 5. These convex portions 74 are arranged at a predetermined distance L apart from each other along the profile of the film 5. This predetermined distance L may be determined as appropriate depending on the level of electromagnetic waves at which the leakage thereof through the gaps between the adjacent convex portions 74 should be prevented. For example, in order to prevent electromagnetic waves of 1 GHz or less from leaking to the outside of the device through the gaps between the adjacent convex portions 74, this predetermined distance L is preferably 7.5 cm or less, which is one fourth of the wavelength of the electromagnetic waves of 1 GHz or less.

Each of the convex portions 74 protrudes, with a pentangular cross section as shown in FIG. 2, extending along the profile of the film 5, and has an angular-shaped top. It is preferable that the length of this convex portion 74 also is 7.5 cm or less, from the viewpoint of reducing the size of concave portions 41 to be described below. For example, the dimensions of the convex portion 74 may be 1 cm wide and 5 cm long. More specifically, as shown in FIG. 6, the convex portion 74 has: a pair of vertical surfaces 74a, each of which is vertical to the facing surface 73a and has a horizontally long rectangular shape extending along the profile of the film 5; a pair of inclined surfaces 74b each of which is inclined inwardly and upwardly from the upper edge of the vertical surface 74a; and a pair of side surfaces 74c each of which is vertical to the facing surface 73a and has a pentangular shape. When the side portions 7a to 7d are pressed into shape, these convex portions 74 also can be formed at the same time. Alternatively, the convex portions 74 may be produced separately and bonded to the press-shaped side portions 7a to 7d by resistance welding, with a conductive adhesive, or the like. The convex portions 74 may be either hollow or solid as long as the convex portions 74 are connected with the facing surface 73a electrically.

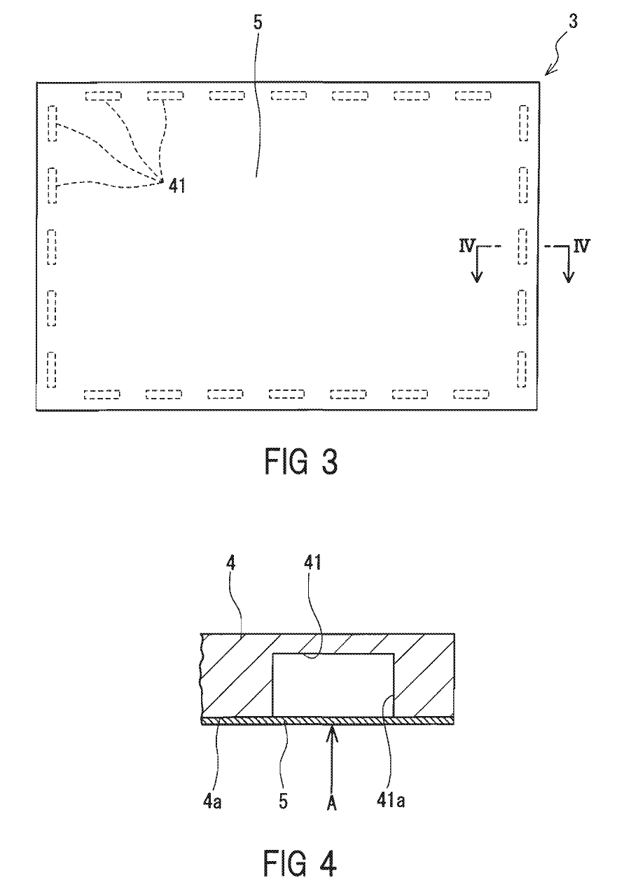

On the rear surface 4a of the transparent substrate 4, concave portions 41 are formed respectively at the positions corresponding to the convex portions 74, as shown in FIG. 3. The concave portions 41 each have a rectangular shape having almost the same size as the convex portions 74, as viewed on the plane. As shown in FIG. 2, each of the convex portions 74 penetrates the film 5 at the position of the corresponding concave portion 41. Each of the convex portions 74 is fitted in the corresponding concave portion 41 with the film 5 interposed therebetween. It is preferable that the width of the concave portion 41 is greater than that of the convex portion 74 by about twice the thickness of the film 5 so that the film 5 is interposed with no space between the inner periphery 41a of the concave portion 41 and the side surfaces 74c of the convex portion 74. The length of the concave portion 41 may be almost the same as or longer than that of the convex portion 74. The concave portions 41 of the transparent substrate 4 can be formed by using a mold having projections corresponding to the concave portions 41 formed thereon when producing the transparent substrate 4, or by machining the transparent substrate 4 after producing it.

The plasma display device 1 as described above may be manufactured in the following manner.

First, the concave portions 41 are formed respectively at the positions corresponding to the convex portions 74 of the conductive member 7 on the periphery of the rear surface 4a of the transparent substrate 4. Next, the film 5 is attached to the rear surface 4a of the transparent substrate 4. Thus, the optical filter 3 as shown in FIGS. 3 and 4 is produced. In this case, all the concave portions 41 are covered with the film 5.

After that, the conductive member 7 is disposed at the film 5 side of the optical filter 3, and the conductive member 7 is pressed against the transparent substrate 4 from the side of the film 5 in such a manner that the positions of the convex portions 74 and the positions of the corresponding concave portions 41 are aligned with each other. When the conductive member 7 is pressed, the top of each convex portion 74 first breaks the film 5 at the position corresponding to the center of the concave portion 41. Since the convex portion 74 has a shape of a protruded ridge with an angular top, it easily can break the film 5 in a straight line. As the convex portion 74 is further pressed into the concave portion 41, the film 5 is gradually broken along the side edges of the inclined surfaces 74b of the convex portion 74, and the portions of the film 5 broken in a U shape are pressed up by the inclined surfaces 74b. Thus, the film 5 is pressed into the concave portion 41 while being penetrated by the convex portion 74. As a result, the convex portion 74 can be fitted in the concave portion 41 with the film 5 interposed between the vertical surfaces 74a of the convex portion 74 and the inner periphery 41a of the concave portion 41. In order to break the film 5 without fail at the position corresponding to the center of the concave portion 41, an incision extending in the longitudinal direction of the concave portion 41 may be made at the position indicated by an arrow A in FIG. 4 after producing the optical filter 3. Alternatively, the incision may have an I-shape corresponding to the size of the concave portion 41.

In the plasma display device 1 of the present embodiment, the convex portions 74 provided in places along the profile of the film 5 are fitted in the concave portions 41 of the transparent substrate 4. Therefore, it is possible to prevent a relative displacement between the conductive member 7 and the film 5 attached to the transparent substrate 4, and thus to prevent friction between the film 5 and the conductive member 7. The convex portions 74 are fitted in the concave portions 41 with the film 5 interposed therebetween. Therefore, it is possible not only to bring the conductive member 7 into surface contact with the film 5 reliably but also to secure a large contact area, and thus to maintain the impedance therebetween at a low level. As described above, according to the present embodiment, it is possible to achieve, without using a conductive gasket but at a low cost, prevention of friction between the film 5 and the conductive member 7 as well as reliable electrical connection between them with low impedance. In addition, the present embodiment makes it possible to omit complicated work such as attaching a conductive gasket, and thus simplify the manufacturing process, compared to the case of using a conductive gasket.

In the present embodiment, the concave portions 41 are formed respectively at positions corresponding to the convex portions 74. However, four concave portions each having a linear groove shape may be formed respectively on the four side positions 7a to 7d, or one concave portion having a rectangular groove shape as viewed from the front may be formed. When the concave portions 41 are formed respectively to be fitted with the corresponding convex portions 74, as in the present embodiment, the adequate strength of the transparent substrate 4 can be ensured.

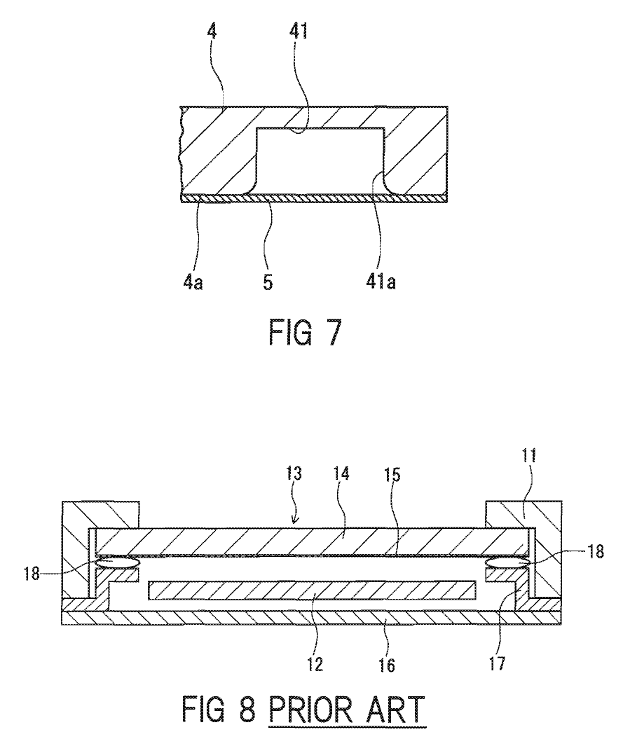

As shown in FIG. 7, the corner portions formed by the inner peripheral surface 41a of the concave portion 41 and the rear surface 4a of the transparent substrate 4 may be rounded off. By rounding the corner portions, it is possible to inhibit the rupture of the film 5 at the corner portions when the convex portions 74 are pressed into the concave portions 41.

Furthermore, the concave portions 41 may be formed on the front surface of the transparent substrate 4 located at the opposite side to the side of the PDP 2 and the film 5 may be attached to this front surface. In this case, the plasma display device 1 may be configured in such a manner that the conductive member 7 presses the optical filter 3 toward the PDP 2. In other words, the first surface in the present invention may be either the front surface or the rear surface of the transparent substrate 4.

The convex portions 74 each may have a cylindrical column shape having a conical top. Electromagnetic waves can be blocked surely from leaking to the outside of the device at the positions where the convex portions 74 exist. Thus, when the convex portions 74 each protrude extending along the profile of the film 5, as shown in the present embodiment, a larger area can be secured for surely blocking the electromagnetic waves.

Furthermore, it is also possible to hold the optical filter 3 only with the conductive member 7, without the frame 8.

According to the present invention, the transparent substrate and the film are fixed to the conductive member so that they are relatively immobilized. Therefore, without a conductive gasket interposed between the film and the conductive member, it is possible to surely prevent the friction between them and thus connect them electrically with low impedance and with reliability. As a result, it becomes possible to obtain the shielding effect of the plasma display device entirely at a low cost and with reduced man-hours.

What is claimed is:

1. A plasma display device comprising:
a plasma display panel;
a transparent substrate disposed at a front side of the plasma display panel;
a film attached to a first surface of the transparent substrate and having a conductive layer;
a conductive back cover disposed at a rear side of the plasma display panel; and
a conductive member that electrically connects a periphery of the film and a periphery of the back cover,
wherein the conductive member has a facing surface facing the periphery of the film at a side opposite to the transparent substrate, and convex portions are formed on the facing surface at a predetermined distance apart from each other, and
a concave portion or concave portions are formed on the first surface of the transparent substrate, and the convex portions are fitted in the concave portion or the concave portions with the film interposed therebetween.

2. The plasma display device according to claim 1,
wherein the convex portions penetrate the film.

3. The plasma display device according to claim 1,
wherein the convex portions each have an angular top.

4. The plasma display device according to claim 3,
wherein the convex portions each protrude extending along a profile of the film.

5. The plasma display device according to claim 1,
wherein the predetermined distance is 7.5 cm or less.

6. The plasma display device according to claim 1,
wherein the concave portions are formed respectively at positions corresponding to the convex portions.

7. The plasma display device according to claim 1,
wherein corner portions formed by an inner peripheral surface of the concave portion and the first surface of the transparent substrate are rounded off.

8. A method of manufacturing a plasma display device, comprising pressing a conductive member against a transparent substrate from a side of a film of the substrate, the conductive member having a facing surface facing a periphery of the film and convex portions formed on the facing surface at a predetermined distance apart from each other, and the transparent substrate having a first surface with a concave portion or concave portions formed on the periphery thereof and with the film having a conductive layer attached to the first surface, so that the convex portions are pressed into the concave portion or the concave portions so as to penetrate the film, and thus the convex portions are fitted in the concave portion or the concave portions with the film interposed therebetween.
